(19) United States
(12) Patent Application Publication
(10) Pub. No.: US 2009/0267908 A1
(43) Pub. Date: Oct. 29, 2009

(54) TOUCH SCREEN DEVICE COMPRISING A GRAPHIC INTERFACE AND A CONTROL METHOD OF THE TOUCH SCREEN

(75) Inventors: I-His Wu, Taipei (TW); I-Chiech Huang, Taipei (TW); Wei-Ling Hsu, Taipei (TW)

Correspondence Address: Chih Feng Yeh;BRIAN M. MCINNIS, 12th Floor, Ruttonjee House, 11 Duddell Street, Hong Kong, HK

(73) Assignee: COMPAL ELECTRONICS, INC., TAIPEI (TW)

(21) Appl. No.: 12/330,520

(22) Filed: Dec. 9, 2008

(30) Foreign Application Priority Data
Apr. 29, 2008 (TW) 97115738

(51) Int. Cl. G06F 3/041

(52) U.S. Cl. 345/173

(57) ABSTRACT

A touch screen device comprising a graphic interface and a control method of the touch screen are provided. The touch screen device comprises a monitor and a touch sensing pad. The touch sensing pad is used to sense a touching activity. The monitor is electrically connected to the touch sensing pad and is used to display a graphic interface. The graphic interface comprises a first menu and a plurality of second menus. The first menu is displayed on the monitor and comprises a plurality of first objects, wherein the first objects are displayed as two arcs on the two sides of the graphic interface. The second menus are respectively corresponding to one of the first objects. Each of the second menus is displayed in the middle of the two arcs of the first menu when the touching activity is performed on the corresponding first object.

### RELATED APPLICATIONS

This application claims priority to Taiwan Application Serial Number 97115738, filed Apr. 29, 2008, which is herein incorporated by reference.

### BACKGROUND

1. Field of Invention

The present invention relates to a touch screen device. More particularly, the present invention relates to touch screen device comprising a graphic interface.

2. Description of Related Art

Portable electronic devices become indispensable in our daily life. The conventional device to control the portable electronic device is through the use of keypad. Recently, many portable electronic devices also comprise touch screens to provide the users a convenient way to control the portable electronic devices. In order to control a portable electronic device, the user has to hold the device in one hand and uses the finger of the other hand, or a pen hold in the other hand to touch the touch screen. If the user stands in a moving car that shakes a lot, the portable electronic device is easy to fall when the user holds the device with only one hand.

Accordingly, what is needed is a graphic interface, a touch screen device, and a control method of the touch screen device to overcome the above issues. The present invention addresses such a need.

### SUMMARY

A touch screen device is provided. The touch screen comprises a touch sensing pad and a monitor. The touch sensing pad is to sense a touching activity; and the monitor is electrically connected to the touch sensing pad to display a graphic interface, wherein the graphic interface comprises a first menu and a plurality of second menus. The first menu comprises a plurality of first objects displayed as two arcs on the two sides of the graphic interface; and each of the plurality of second menus corresponds to one of the first objects, wherein each of the second menus is displayed in the middle of the two arcs of the first menu when the touching activity is performed on the corresponding first object.

Another object of the present invention is to provide a control method of a touch screen device, wherein the touch screen device comprises a touch sensing pad and a monitor. The control method comprises the steps of: providing a first menu on a graphic interface of the monitor, wherein the first menu comprises a plurality of first objects displayed as two arcs on the two sides of the graphic interface; providing a plurality of second menus each corresponding to one of the plurality of first objects, wherein each of the second menus is displayed in the middle of the two arcs of the first menu; and performing a touching activity on one of the plurality of the first objects to make the second menu corresponding to the first object be displayed on the graphic interface.

Yet another object of the present invention is to provide a graphic interface comprising a first menu and a plurality of second menus. The first menu comprises a plurality of first objects displayed as two arcs on the two sides of the graphic interface; and each of the plurality of second menus corresponds to one of the first objects, when a touching activity is performed on one of the first objects, a second menu corresponding to the first object is displayed on the graphic interface.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a side view of an electronic device of the first embodiment of the present invention;

FIG. 2A is a top view of the touch screen of the first embodiment of the present invention;

FIG. 2B is a diagram of a touching activity, which is a trajectory of an object on the touch screen, to control the graphic interface;

FIG. 2C is a diagram of a touching activity, which is a pressure on the touch screen performed by an object, to control the graphic interface;

FIG. 3A and FIG. 3B are the top views of the touch screen of the two embodiments of the present invention; and

FIG. 4 is a flow chart of the control method of an embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

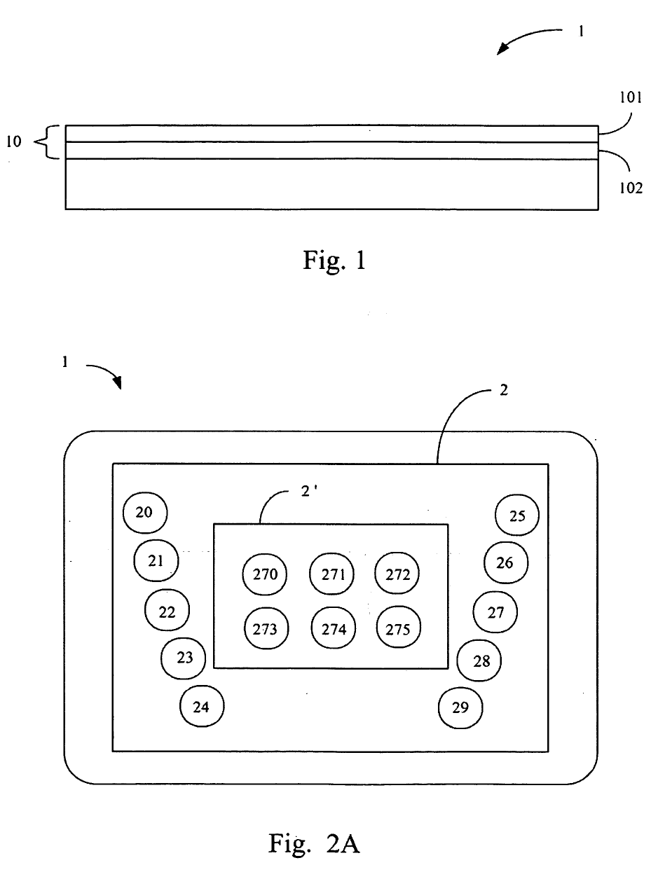

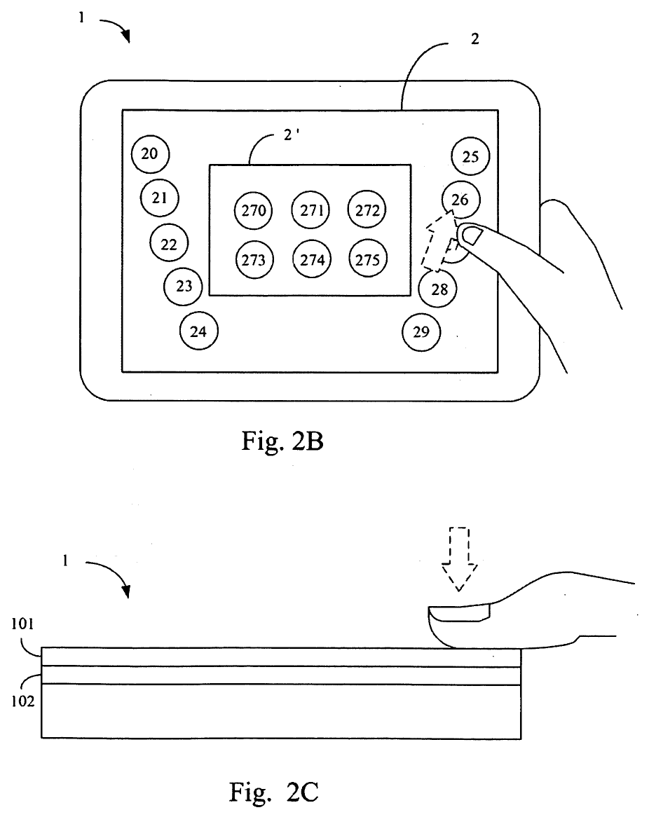

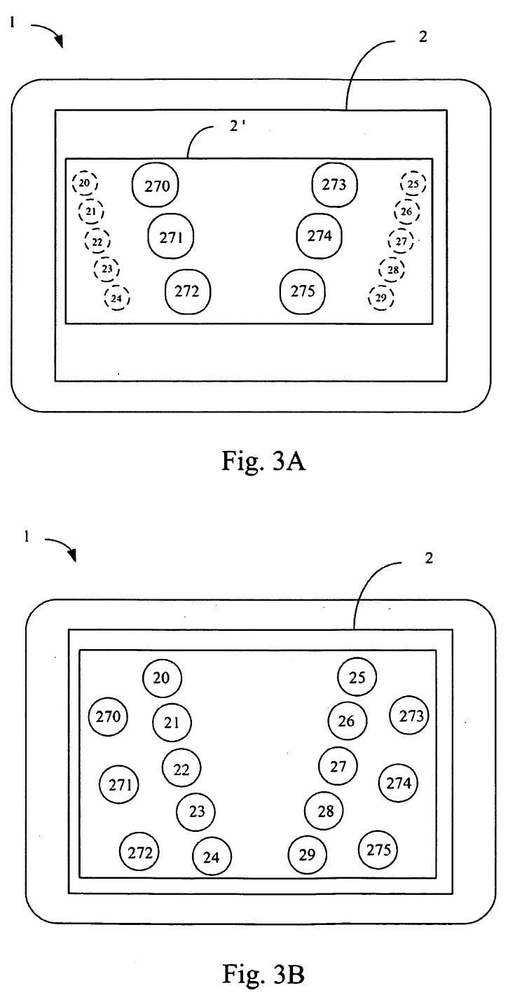

Please refer to FIG. 1, a side view of an electronic device 1 of the first embodiment of the present invention. A touch screen 10 is adapted in the electronic device 1. FIG. 2A is a top view of the touch screen 10. Please refer to FIG. 1 and FIG. 2A at the same time. The touch screen 10 comprises a touch sensing pad 102 and a monitor 101. The touch sensing pad 102 is to sense a touching activity, wherein in the present embodiment, wherein the touching activity is a trajectory of an object. For example, if the user uses a finger slides through the touch sensing pad 102, the touch sensing pad 102 will sense the position of the trajectory of the sliding finger. The monitor 101 is electrically connected to the touch sensing pad 102 to display a graphic interface 2, wherein the graphic interface 2 comprises a first menu. The first menu of the present embodiment comprises ten first objects 20, 21, . . . , 29. In other embodiment, people skilled in the art can modify the number of the first objects of the first menu according to different situations. The first objects 21, . . . , 29 of the first menu are displayed as two arcs on the two sides of the graphic interface 2 on the monitor 101. As shown in FIG. 2A, the first objects 20, . . . , 24 are displayed as an arc on the left side of the graphic interface 2, and the first objects 25, . . . , 29 are displayed as an arc on the right side of the graphic interface 2. The arrangement of the two arcs on two sides of the monitor 101 is convenient for the user to hold the electronic device 1 with two hands and control the electronic device 1 with two hands as well. Thus, even the user stays in a moving car, the user can still hold the electronic device tight. It's noticed that the number of the first objects on the arcs of two sides is not necessary the same. The graphic interface 2 further comprises ten second menus corresponding to the ten first objects 20, . . . , 29. When the touch sensing pad 102 senses a trajectory of the object passing through one of the first objects 20, . . . , 29, the second menu corresponding to the first object being touched is displayed in a middle area 2′ of the two arcs of the first menu of the graphic interface 2 of the monitor 101. Please refer to FIG. 2B, a diagram showing a trajectory of a finger of the user passing through a first object. As shown in FIG. 2B, after the trajectory passes through the first object 27, the corresponding second menu is shown on the middle area 2′ of the graphic interface 2 of the monitor 101. Each of the second menus further comprises a plurality of second objects. As shown in the middle part of the graphic interface 2 in FIG. 2B, there are six second objects 270, 271, . . . , 275 of the second menu corresponding to the first object 27. In other embodiment, people skilled in the art can modify the number of the second objects of the second menu according to different situations. When the touching activity, such as the trajectory of an object mentioned above, is performed on one of the plurality of the second objects 270, . . . , 275, the electronic device 1 starts to operate a program (not shown) corresponding to the second object. Although the embodiment describes that the second menu is shown in the middle of area 2′ of the two arcs of the first menu of the graphic interface 2, the second menu may be also displayed on the full screen of the monitor 101 in some conditions. For instance, when the first objects are deactivated, faint or the first menu and the second menu are arranged in different layers as depicted in FIG. 3A. In FIG. 3A, the first objects are blurred in a lower layer and the second menu stands out in an upper layer. Another embodiment, the second menu could be displayed on the screen of the monitor 101 outside the two arcs area of the first menu of the graphic interface 2. Or the second menu may be displayed as two arcs of the two sides of graphic interface 2. As depicted in FIG. 3B, the second menu is displayed outside the two arcs area of the first menu as two arcs.

In another embodiment, the touching activity can be a pressure on the touch screen performed by an object. For example, if the user uses a finger to press the touch sensing pad 102, the touch sensing pad 102 will sense the position of the pressure performed. FIG. 2C is a diagram showing a user using a finger to tap on the touch sensing pad 102 to perform a pressure. The touch sensing pad 102 senses the position of the pressure, finds the objects of the first or second menus corresponding to the position and further controls the electronic device 1. When the pressure is performed on one of the plurality of the first objects, the second menu corresponding to the first object is displayed.

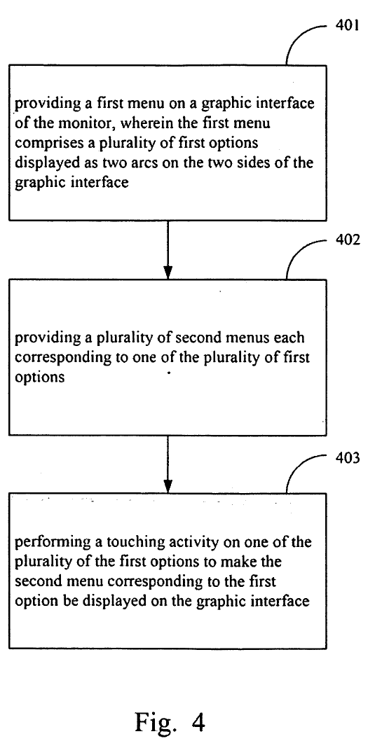

Another embodiment of the present invention is a control method of a touch screen device, wherein the touch screen device comprises a touch sensing pad and a monitor. Please refer to FIG. 4, a flow chart of the control method of the present invention. The control method comprises the steps of: in step 401, providing a first menu on a graphic interface of the monitor, wherein the first menu comprises a plurality of first objects displayed as two arcs on the two sides of the graphic interface; in step 402, providing a plurality of second menus each corresponding to one of the plurality of first objects, wherein each of the second menus is displayed in the middle of the two arcs of the first menu; then in step 403, performing a touching activity on one of the plurality of the first objects to make the second menu corresponding to the first object be displayed on the graphic interface.

The touch screen of the present invention provides the arc-shaped objects of the menu on two sides of the graphic interface of the monitor to allow is the user to control the electronic device and hold the electronic device with two hands at the same time.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A touch screen device, comprising:
a touch sensing pad to sense a touching activity; and
a monitor electrically connected to the touch sensing pad to display a graphic interface, wherein the graphic interface comprising:
a first menu comprising a plurality of first objects displayed as two arcs on the two sides of the graphic interface; and
a plurality of second menus each corresponding to one of the first objects, wherein each of the second menu is displayed when the touching activity is performed on the corresponding first object.

2. The touch screen device of claim 1, wherein the touching activity is a trajectory on the touch screen, when the trajectory passes through one of the plurality of the first objects, the second menu corresponding to the first object being touched is displayed.

3. The touch screen device of claim 1, wherein the touching activity is a pressure on the touch screen, when the pressure is performed on one of the plurality of the first objects, the second menu corresponding to the first object being touched is displayed.

4. The touch screen device of claim 1, wherein each of the second menu further comprises a plurality of second objects.

5. The touch screen device of claim 4, wherein the touch screen device is adapted in an electronic device, when the touching activity is performed on one of the plurality of the second objects, the electronic device starts to operate a program corresponding to the second object being touched.

6. The touch screen device of claim 1, wherein the second menu is displayed in the middle of the two arcs of the first menu.

7. The touch screen device of claim 1, wherein the second menu is displayed as two arcs on the two sides of the graphical user interface.

8. The touch screen device of claim 1, wherein the second menu is displayed outside the two arcs of the first menu.

9. The touch screen device of claim 1, wherein the second menu is displayed when the first objects are deactivated, faint or the first menu and the second menu are arranged in different layers.

10. The touch screen device of claim 1, wherein the second menu is displayed on the full screen of the monitor.

11. A control method of a touch screen device, wherein the touch screen device comprises a touch sensing pad and a monitor, the control method comprises the steps of:
providing a first menu on a graphic interface of the monitor, wherein the first menu comprises a plurality of first objects displayed as two arcs on the two sides of the graphic interface;
providing a plurality of second menus each corresponding to one of the plurality of first objects, wherein each of the second menus is displayed; and
performing a touching activity on one of the plurality of the first objects to make the second menu corresponding to the first object be displayed on the graphic interface.

12. The control method of claim 11, wherein the touching activity is a trajectory, when the trajectory passes through one of the plurality of the first objects, the second menu corresponding to the first object being touched is displayed.

13. The control method of claim 11, wherein the touching activity is a pressure on the touch screen, when the pressure is performed on one of the plurality of the first objects, the second menu corresponding to the first object being touched is displayed.

14. The control method of claim 11, wherein the second menu is displayed in the middle of the two arcs of the first menu.

15. The control method of claim 11, wherein the second menu is displayed as two arcs on the two sides of the graphical user interface.

16. The control method of claim 11, wherein the second menu is displayed outside the two arcs of the first menu.

17. The control method of claim 11, wherein the second menu is displayed when the first objects are deactivated, faint or the first menu and the second menu are arranged in different layers.

18. The control method of claim 11, wherein the second menu is displayed on the full screen of the monitor.

19. A graphical user interface which provides for user selection of a plurality of functions that can be performed via a touch screen device, comprising:
a first menu comprising a plurality of first objects displayed as two arcs on the two sides of the graphical user interface on the touch screen device; and
a plurality of second menus each corresponding to one of the first objects, when a touching activity is performed on one of the first objects, a second menu corresponding to the first object being touched is displayed on the graphical user interface on the touch screen device.

20. The graphical user interface of claim 19, wherein the second menu is displayed in the middle of the two arcs of the first menu.

21. The graphical user interface of claim 19, wherein the second menu is displayed as two arcs on the two sides of the graphical user interface.

22. The graphical user interface of claim 19, wherein the second menu is displayed outside the two arcs of the first menu.

23. The graphical user interface of claim 19, wherein the second menu is displayed when the first objects are deactivated, faint or the first menu and the second menu are arranged in different layers.

24. The graphical user interface of claim 19, wherein the second menu is displayed on the full screen of the monitor.
